(19) United States
(12) Patent Application Publication
(10) Pub. No.: US 2012/0268305 A1
(43) Pub. Date: Oct. 25, 2012

(54) Stealth detector

(76) Inventor: William F. Macsisak, Plano, TX (US)

(21) Appl. No.: 13/066,762

(22) Filed: Apr. 25, 2011

(51) Int. Cl. G01S 7/42

(52) U.S. Cl. 342/13

(57) ABSTRACT

The idea for a Stealth Detector was generated by the statement of American military that Stealth technology could never be defeated. The American military stated Stealth technology allows a Stealth plane to send a very small radar signal back to a radar installation, that cannot be interpreted as a plane. So I thought in order to determine if a radar signal of an object is correctly being reported, is to not try to determine its shape, but to determine its size. I thought in order to determine the correct size of a radar object you will need a Stealth Detector composed of three radars. The three radars should be aimed at slightly different angles. The three radar signals will each send a radar signal back to a radar installation. Then a computer or human analyst should determine if the three radar signals show the object is a Stealth plane.

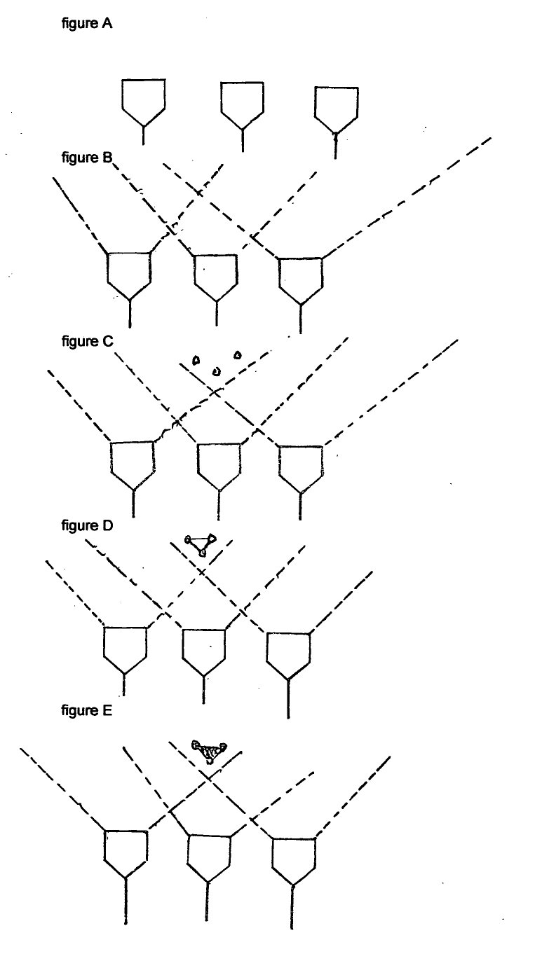

To build my Stealth Detector invention you need at least 3 linked radars operating simultaneously aimed at slightly different angles covering the same area.

If the three radars are aimed at the same stealth object they will produce three separate small images.

The three separate small images then need to be subjected to a computer imaging program that draws a line between the three small images.

The computer imaging program then fills in the area inside the line.

Then you would have a computer or a human radar analyst determine if the computer imaged area is large enough to be a stealth plane or object and then advise a military target tracker where the stealth plane or object is located, so it can then be targeted and destroyed.

Please see the following descriptions/drawings of the Stealth Detector.

Note I made the area between the 3 different radars larger than the stealth object to emphasize the radar picture.

### DETAILED DESCRIPTION AND DRAWINGS OF INVENTION

### Descriptions

The first requirement of Stealth Detector is you need three radars operating simultaneously, see page 5, figure A .

The second requirement of Stealth Detector is you need to aim the three radars at different angles at the same area “Stealth object”, see page 5, figure B.

The third requirement of Stealth Detector is that each one of the three radars will produce an individual image, see page 5, figure C.

The fourth requirement of Stealth Detector is that a computer receives the three images and then draws a line between the images, see page 5, figure D.

The fifth requirement of Stealth Detector is that line between the three images is filled in, so it can be used as the location of the Stealth object, see page 5, figure E.

1. The Stealth Detector will allow all objects built using stealth technology to be located, tracked, targeted and destroyed.
